(19) United States
(12) Patent Application Publication
(10) Pub. No.: US 2006/0054379 A1
(43) Pub. Date: Mar. 16, 2006

(54) Sound box vibration-proof seat

(76) Inventor: Steven Chang, Taipei Hsien (TW)

Correspondence Address: STEVEN CHANG, 235 Chung - Ho, Box 8-24, Taipei, TW

(21) Appl. No.: 10/939,557

(22) Filed: Sep. 14, 2004

(51) Int. Cl. F16F 7/00; F16F 15/00

(52) U.S. Cl. 181/207; 181/209

(57) ABSTRACT

A sound box vibration-proof seat comprises a top center having a tapered portion at one end thereof; another end of the top center being a stud; the stud being installed with a locking sleeve, a washer, a locking nut and a buckling nut; a seat pad having a recess at a top center thereof for receiving the tapered portion; an outer periphery of the seat pad having an inward engaging surface for tightly engaging an open end of the vibration-reduction cover; and a vibration-reduction cover enclosing the tapered portion; the vibration-reduction cover having a close end; and a center of the close end having a through hole. After the sound box has been moved, a time period is required to correct the position of the top center with respect to the seat pad.

### FIELD OF THE INVENTION

The present invention relates to sound boxes, and particularly to a sound box vibration-proof seat, wherein a special vibration-reduction cover is disclosed, which is used to combine the top center with the seat pad. Thereby the sound box can be displaced easily with less vibration. Since the through hole of the vibration-reduction cover is larger to be sufficient to allow a sufficient margin after the stud of the top center is installed. Thereby the original effect is retained.

### BACKGROUND OF THE INVENTION

The vibration proof design is very import to audio devices. This is because the rotation of some electric parts of the audio device will affect the quality of the sound. The vibration sources of audio devices include motors, transformers, microphones, etc. To avoid the prior art defects, many different kinds of vibration-proof devices are developed, such as hard tapered nails or soft vibration absorption pads.

Referring to FIG. 1, the vibration-proof pad 1 of a sound box includes a top pin 10 and disk seat 11. The top pin 10 is a tapered tip 101 at one end thereof and another end thereof is a stud 102. A tightening block 103, a washer 104, a screwing nut 105 and a positioning nut 106 are installed on the stud 102. A groove 111 is formed on a center of the disk seat 11. With reference to FIG. 2, a plurality of blocks 103 are arranged at a bottom of holes of a sound box along a triangular shape or a rectangular shape. A plurality of top pins 10 with washers 104, tightening nuts 105, positioning nuts 106 are screwed and positioned by studs 102. A plurality of disk seats 11 are formed below each top pins 10 so that the tapered tips 101 of the top pins 10 are placed within the grooves 111 so that the sound box has the effect of vibration proof.

Although above mention prior arts have desired effect of vibration proof, when it is desired to move the sound box, the top pins must be separated from the disk seat. As the sound box is moved to a predetermined position, they are reassembled. If the sound box has a larger volume and is heavy, the work become difficult.

### SUMMARY OF THE INVENTION

Accordingly, the primary object of the present invention is to provide a sound box vibration-proof seat, wherein a special vibration-reduction cover is disclosed, which is used to combine the top center with the seat pad. Thereby the sound box can be displaced easily with less vibration. Since the through hole of the vibration-reduction cover is larger to be sufficient to allow a sufficient margin after the stud of the top center is installed. Thereby the original effect is retained.

To achieve above objects, the present invention provides a sound box vibration-proof seat which comprises a top center having a tapered portion at one end thereof; another end of the top center being a stud; the stud being installed with a locking sleeve, a washer, a locking nut and a buckling nut; a seat pad having a recess at a top center thereof for receiving the tapered portion; an outer periphery of the seat pad having an inward engaging surface for tightly engaging an open end of the vibration-reduction cover; and a vibration-reduction cover enclosing the tapered portion; the vibration-reduction cover having a close end; a center of the close end having a through hole. After the sound box has been moved, a time period is required to correct the position of the top center with respect to the seat pad.

The various objects and advantages of the present invention will be more readily understood from the following detailed description when read in conjunction with the appended drawing.

### BRIEF DESCRIPTION OF THE DRAWINGS

FIG. 1 is an exploded schematic view of a prior art vibration-proof seat.

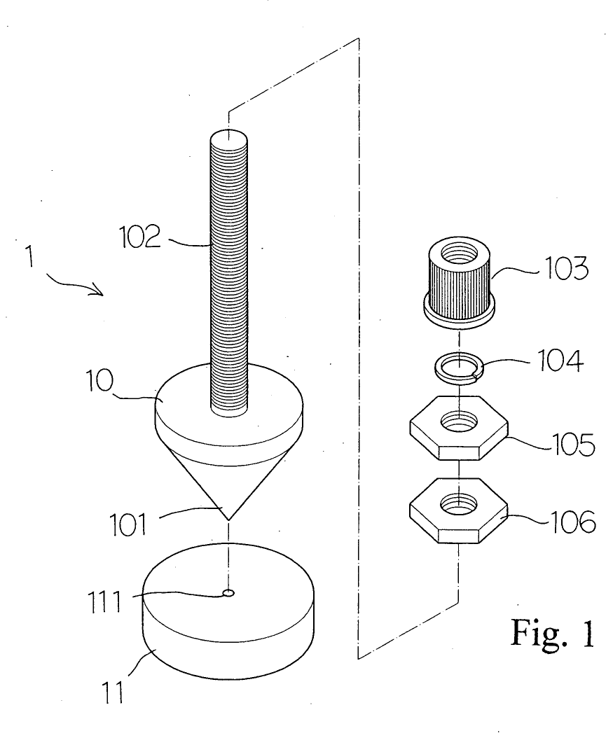

FIG. 2 is a schematic view showing the use of the prior art vibration-proof seat.

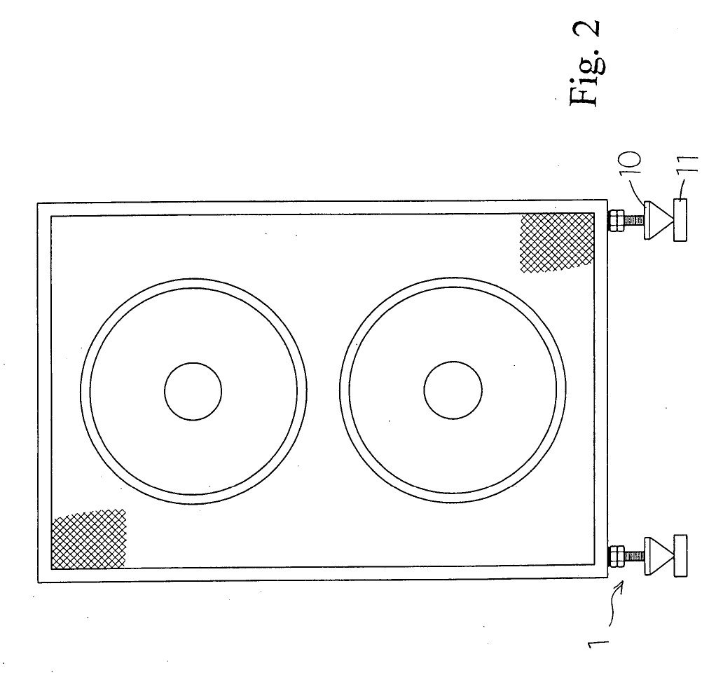

FIG. 3 is a structural exploded view of one embodiment of the present invention.

FIG. 4 is an assembled view of the embodiment of the present invention.

FIG. 5 is a perspective view about the structure of the embodiment of the present invention.

FIG. 6 is a schematic view showing the application of the embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

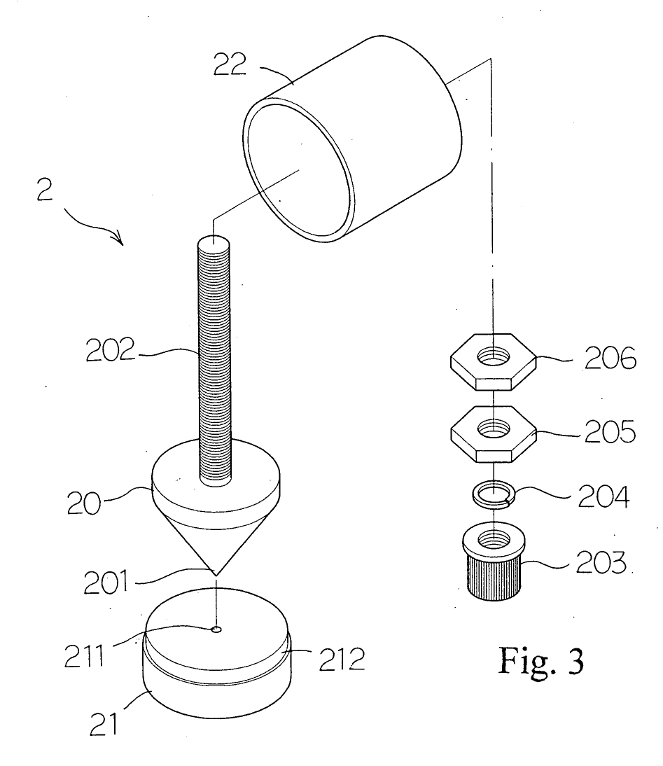

With reference to FIG. 3, the sound box vibration-proof seat of the present invention has the following elements.

A top center 20 is a tapered portion 201 at one end thereof. Another end of the top center 20 is a stud 202. The stud 202 is installed with a locking sleeve 203, a washer 204, a locking nut 205 and a buckling nut 206, etc.

A seat pad 21 has a recess 211 at a top center thereof for receiving the tapered portion 201. An outer periphery of the seat pad 21 has an inward engaging surface 212 for tightly engaging an open end of the vibration-reduction cover 22.

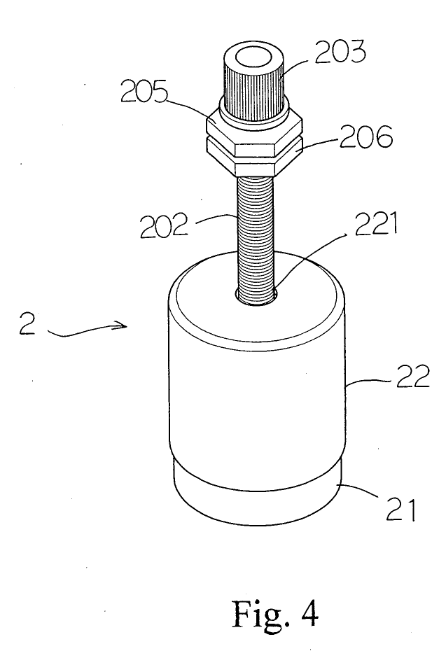

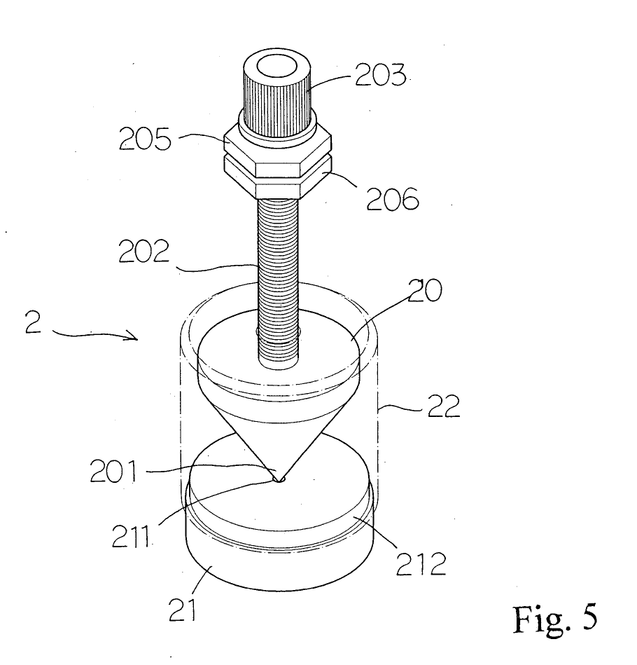

A vibration-reduction cover 22 encloses the tapered portion 201. The vibration-reduction cover 22 has a close end. A center of the close end has a through hole 221. A diameter of the through hole 221 is slightly larger than that of the stud 202 of the top center 20, as shown in FIGS. 4 and 5.

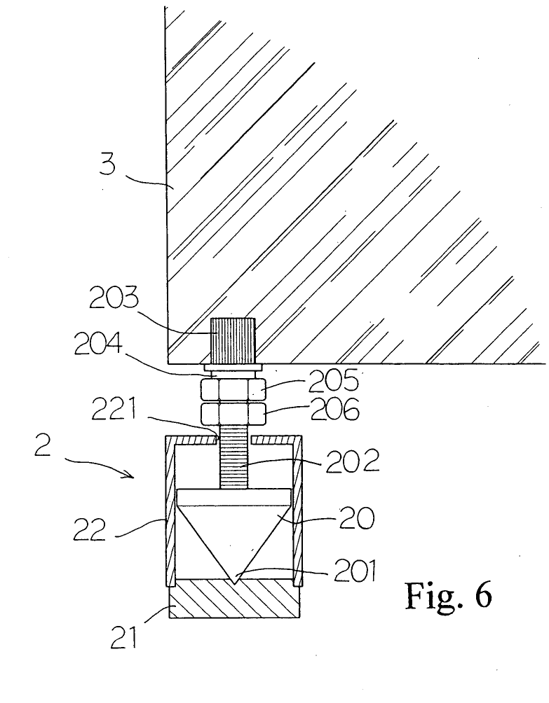

Referring to FIG. 6, in assembly, the locking sleeve 203 is combined to a predetermined position of a bottom of the sound box 3. Then the top center 20, seat pad 21, and the vibration-reduction cover 22 are screwed to the locking sleeve 203 through the buckling nut 206. Then the locking nut 205 serves to further firmly lock the structure. Thereby the assembly of the sound box vibration-proof seat 2 is completed so as to have the effect of vibration-proof. Thus, when it is desired to move the sound box 3, since the top center 20 has combined to the seat pad 21, it can be displaced easily. After the sound box 3 has been moved, a time period is required to correct the position of the top center 20 with respect to the seat pad 21.

In the present invention, a special vibration-reduction cover is disclosed, which is used to combine the top center with the seat pad. Thereby the sound box can be displaced easily with less vibration. Since the through hole of the vibration-reduction cover is larger to be sufficient to allow a sufficient margin after the stud of the top center is installed. Thereby the original effect is retained.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sound box vibration-proof seat comprising:
a top center having a tapered portion at one end thereof; another end of the top center being a stud; the stud being installed with a locking sleeve, a washer, a locking nut and a buckling nut;
a seat pad having a recess at a top center thereof for receiving the tapered portion; an outer periphery of the seat pad having an inward engaging surface for tightly engaging an open end of the vibration-reduction cover; and
a vibration-reduction cover enclosing the tapered portion; the vibration-reduction cover having a close end; a center of the close end having a through hole.

2. The sound box vibration-proof seat as claimed in claim 1, wherein a diameter of the through hole is slightly larger than that of the stud of the top center.
